(19) United States
(12) Patent Application Publication
(10) Pub. No.: US 2019/0012292 A1
(43) Pub. Date: Jan. 10, 2019

(54) CONTROL DEVICE

(71) Applicant: Kabushiki Kaisha Toshiba, Minato-ku, Tokyo (JP)

(72) Inventors: Hiroyuki MOMOTAKE, Tokyo (JP); Tatsuo HIROTA, Tokyo (JP)

(21) Appl. No.: 15/511,201

(22) PCT Filed: Mar. 22, 2016
(86) PCT No.: PCT/JP2016/058928

§ 371 Date: Mar. 14, 2017

(51) Int. Cl. G06F 15/167; G06F 11/07

(52) U.S. Cl. CPC G06F 15/167; G06F 11/0721

(57) ABSTRACT

According to one embodiment, a control device includes: a first device having a first controller; a second device having a second controller; a shared memory; and a first circuitry. The shared memory is configured to be shared by the first device and the second device. The first circuitry is configured: to acquire, when the second controller accesses the shared memory, information regarding the access from the second device; and to output, to the first device, the acquired information regarding the access.

### FIELD

Embodiments of the present invention relate to a control device.

### BACKGROUND

Conventionally, there has been known a control device including a processor that carries out a predetermined task. Such a control device may be provided with a plurality of processors.

### CITATION LIST

### Patent Literature

Patent Literature 1: Japanese Laid-open Patent Publication No. 2012-150661

### SUMMARY OF THE INVENTION

### Problem to be Solved by the Invention

In the aforementioned conventional control device provided with the plurality of processors, each of the processors may be configured to transmit/receive data via a single shared memory. In this case, in order to acquire data from another processor, each of the processors needs to repeatedly and periodically access the shared memory to carry out, for example, processing of verifying whether or not data from the other processor has been written to the shared memory, as well as a task set in advance. In this conventional manner, there has been a case where a processing burden increases while data is transmitted/received via the shared memory.

### Means for Solving Problem

A control device according to one embodiment includes: a first device having a first controller; a second device having a second controller; a shared memory; and a first circuitry. The shared memory is configured to be shared by the first device and the second device. The first circuitry is configured: to acquire, when the second controller accesses the shared memory, information regarding the access from the second device; and to output, to the first device, the acquired information regarding the access.

### BRIEF DESCRIPTION OF DRAWINGS

FIG. 1 is an exemplary block diagram illustrating a configuration of a control device according to a first embodiment.

FIG. 2 is an exemplary flowchart illustrating processing carried out by diagnosis circuitry according to the first embodiment.

FIG. 3 is an exemplary flowchart illustrating processing carried out by monitoring circuitry according to the first embodiment.

FIG. 4 is an exemplary flowchart illustrating processing carried out by a CPU of a master device according to the first embodiment.

FIG. 5 is an exemplary block diagram illustrating a configuration of a control device according to a second embodiment.

FIG. 6 is an exemplary flowchart illustrating processing carried out by diagnosis circuitry according to the second embodiment.

FIG. 7 is an exemplary flowchart illustrating processing carried out by monitoring circuitry according to the second embodiment.

FIG. 8 is an exemplary flowchart illustrating processing carried out by a CPU of a master device according to the second embodiment.

### DETAILED DESCRIPTION

Embodiments will be described hereinafter on the basis of the drawings.

### First Embodiment

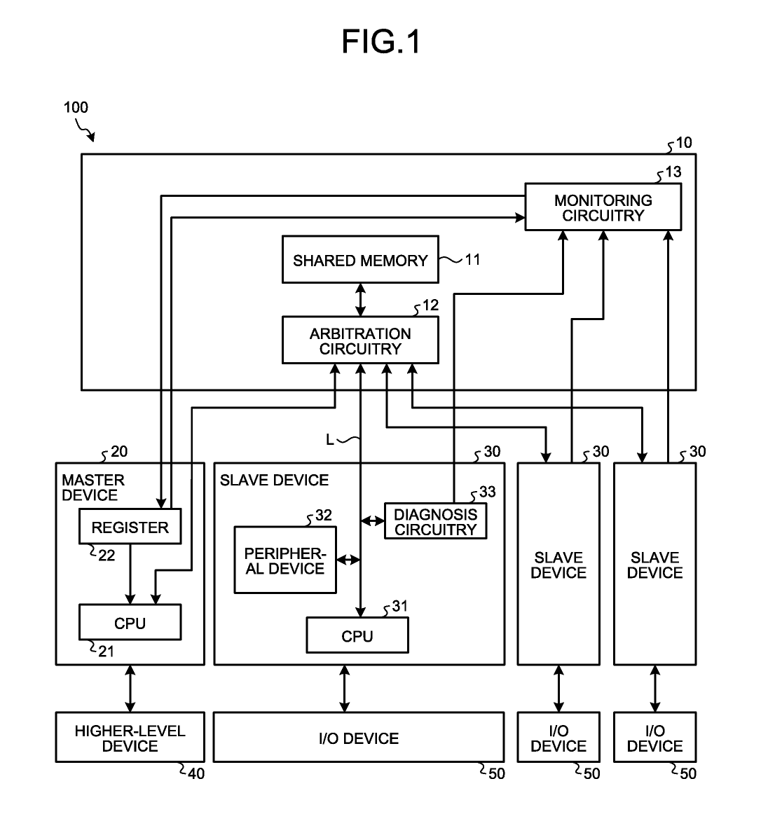

First, a configuration of a control device 100 according to a first embodiment will be described with reference to FIG. 1. The control device 100 is a controller used in an instrumentation field, an electrical control field, an electric power field, and so on.

As illustrated in FIG. 1, the control device 100 includes a motherboard 10, a master device 20, and a plurality of slave devices 30. The master device 20 and the slave devices 30 are connected to the motherboard 10. The master device 20 serves as one example of a “first device”, whereas the slave device 30 serves as one example of a “second device”. Although FIG. 1 has illustrated an example where the three slave devices 30 are provided, as for the number of the slave devices 30, four or more slave devices 30 or two or less slave devices 30 may be employed.

The motherboard 10 includes a shared memory 11 and arbitration circuitry 12. The shared memory 11 is configured so as to be shared by the master device 20 and the slave devices 30. In other words, the master device 20 and the slave devices 30 are configured to transmit and receive data via the shared memory 11. Meanwhile, the arbitration circuitry 12 is configured to arbitrate the competition of access to the shared memory 11. In other words, the arbitration circuitry 12 is configured to prevent the competition between the access to the shared memory 11 by the master device 20 and the access to the shared memory 11 by the slave device 30.

The master device 20 includes a central processing unit (CPU) 21 configured to be able to carry out various types of processing on the basis of data acquired from the slave device 30 via the shared memory 11. In addition, the master device 20 is connected to a higher-level device 40 and configured to be able to output a result of the processing by the CPU 21 to the higher-level device 40. The CPU 21 serves as one example of a “first controller”.

The slave device 30 is connected to an input/output device (I/O device) 50. The slave device 30 includes a CPU 31 configured to be able to carry out various types of processing on the basis of data input via the I/O device 50 and then output a result of the processing to the shared memory 11. The CPU 31 serves as one example of a “second controller”. The slave device 30 also includes a peripheral device 32 such as a memory.

Here, in the first embodiment, the motherboard 10 includes monitoring circuitry 13 configured to acquire, when the CPU 31 accesses the shared memory 11, information regarding this access from the slave device 30 and then transmit, to the master device 20, the acquired information regarding the access. The monitoring circuitry 13 is constituted by hardware such as a field programmable gate array (FPGA). The monitoring circuitry 13 serves as one example of “first circuitry”.

The information regarding the access includes information indicating an address in the shared memory 11 accessed by the CPU 31, information indicating whether data is written or data is read through the access made by the CPU 31, and so on. Such information regarding the access can be acquired by, for example, monitoring a bus between the CPU 31 and the shared memory 11 (refer to a straight line L with arrows in FIG. 1) to intercept a signal output to the shared memory 11 from the CPU 31.

In other words, in the first embodiment, the slave device 30 includes diagnosis circuitry 33 configured to acquire the aforementioned information regarding the access by monitoring the bus between the CPU 31 and the shared memory 11 (refer to the straight line L with arrows in FIG. 1) and then transmit, to the monitoring circuitry 13, the acquired information regarding the access. The diagnosis circuitry 33 is configured by hardware such as a field programmable gate array (FPGA). The diagnosis circuitry 33 serves as one example of “second circuitry”.

Meanwhile, in the first embodiment, the master device 20 includes a register 22 configured to store the information regarding the access acquired from the monitoring circuitry 13. Additionally, the CPU 21 of the master device 20 is configured to access the shared memory 11 on the basis of the register 22.

For example, the diagnosis circuitry 33 is configured to output, when the CPU 31 writes data to the shared memory 11 in order to pass the data to the master device 20, information indicating an address in the shared memory 11, to which the CPU 31 has written the data, and so on, to the monitoring circuitry 13 as the information regarding the access. Additionally, the monitoring circuitry 13 is configured to write, to the register 22 of the master device 20, information that can locate which CPU 31 has written the data to what address in the shared memory 11 on the basis of the information acquired from the diagnosis circuitry 33.

The register 22 is configured to output an interrupt signal to the CPU 21 when the information as mentioned above is written thereto by the diagnosis circuitry 33. Additionally, the CPU 21 is configured to temporarily stop processing currently being carried out when the interrupt signal is input from the register 22 to read information from the register 22 and then access the shared memory 11 on the basis of the read information to acquire, from the shared memory 11, the data written to the shared memory 11 by the CPU 31.

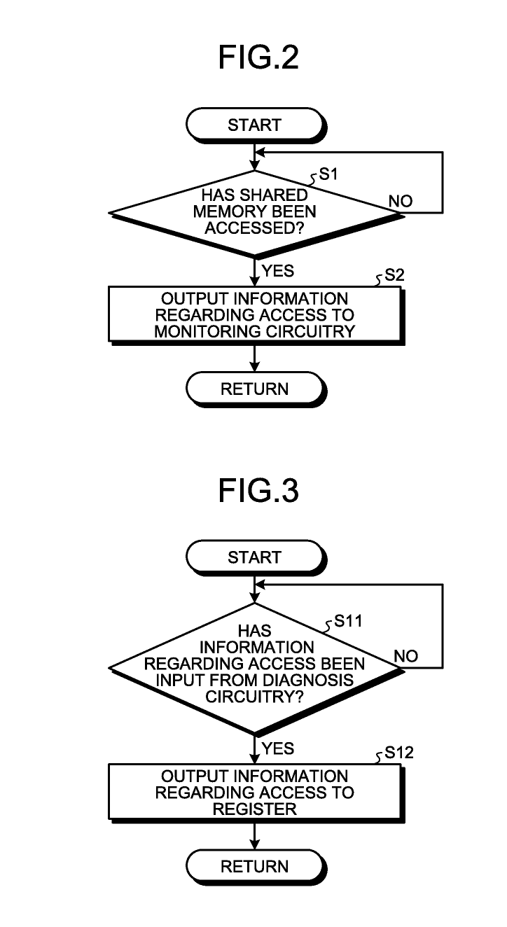

Next, a processing flow carried out by the diagnosis circuitry 33 of the slave device 30 in the control device 100 according to the first embodiment will be described with reference to FIG. 2.

In this processing flow, as illustrated in FIG. 2, the diagnosis circuitry 33 first judges, at step S1, whether the CPU 31 of the slave device 30 has accessed the shared memory 11. More specifically, the diagnosis circuitry 33 monitors the bus between the CPU 31 and the shared memory 11 (refer to the straight line L with arrows in FIG. 1) to judge whether a signal indicating that the CPU 31 has accessed the shared memory 11 is output to the bus. This processing at step S1 is repeated until the CPU 31 is judged to have accessed the shared memory 11. When the CPU 31 is judged at step S1 to have accessed the shared memory 11, the processing proceeds to step S2.

At step S2, the diagnosis circuitry 33 outputs, to the monitoring circuitry 13 of the motherboard 10, the information regarding the access to the shared memory 11 made by the CPU 31. Here, the information regarding the access includes information indicating an address in the shared memory 11 accessed by the CPU 31, information indicating whether data is written or data is read through the access made by the CPU 31, and so on. The information regarding the access is generated on the basis of a signal intercepted from the bus between the CPU 31 and the shared memory 11 (refer to the straight line L with arrows in FIG. 1). Then, the processing returns to the beginning.

Next, a processing flow carried out by the monitoring circuitry 13 of the motherboard 10 in the control device 100 according to the first embodiment will be described with reference to FIG. 3.

In this processing flow, as illustrated in FIG. 3, the monitoring circuitry 13 first judges, at step S11, whether the information regarding the access to the shared memory 11 made by the CPU 31 of the slave device 30 has been input from the diagnosis circuitry 33. This processing at step S11 is repeated until the information regarding the access is judged to have been input from the diagnosis circuitry 33. When the information regarding the access is judged at step S11 to have been input from the diagnosis circuitry 33, the processing proceeds to step S12.

At step S12, the monitoring circuitry 13 outputs, to the register 22 of the master device 20, the information regarding the access input from the diagnosis circuitry 33. For example, when the CPU 31 of the slave device 30 has written data to the shared memory 11, the monitoring circuitry 13 writes, to the register 22, information that can locate what address in the shared memory 11 is used when the CPU 31 has written the data thereto, or the like. Then, the processing returns to the beginning.

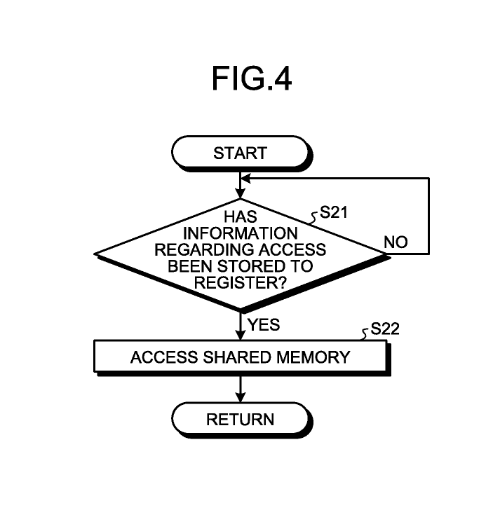

Next, a processing flow carried out by the CPU 21 of the master device 20 in the control device 100 according to the first embodiment will be described with reference to FIG. 4.

In this processing flow, as illustrated in FIG. 4, the CPU 21 first judges, at step S21, whether the information regarding the access to the shared memory 11 made by the CPU 31 has been stored to the register 22. For example, in a case where the register 22 is configured to output the interrupt signal to the CPU 21 when the information regarding the access is stored thereto, the CPU 21 judges, at step S21, whether the interrupt signal from the register 22 has been input to the CPU 21 itself. This processing at step S21 is repeated until the information regarding the access is judged to have been stored to the register 22. When the information regarding the access is judged at step S21 to have been stored to the register 22, the processing proceeds to step S22.

At step S22, the CPU 21 accesses the shared memory 11 on the basis of the information stored to the register 22. For example, when the CPU 31 has written data to the shared memory 11 in order to pass the data to the master device 20, the monitoring circuitry 13 writes, to the register 22, the information that can locate the address in the shared memory 11, to which the CPU 31 has written the data, or the like. Consequently, at step S22, the CPU 21 reads, from the register 22, the information written to the register 22 by the monitoring circuitry 13 and then accesses the shared memory 11 on the basis of the read information, thereby acquiring, from the shared memory 11, the data written to the shared memory 11 by the CPU 31. Then, the processing returns to the beginning.

As described thus far, the control device 100 according to the first embodiment includes the monitoring circuitry 13 that acquires, when the CPU 31 of the slave device 30 accesses the shared memory 11, the information regarding this access from the slave device 30 and then outputs, to the master device 20, the acquired information regarding the access. With this, it is no longer necessary to carry out processing of, for example, repeatedly accessing the shared memory 11 on a regular basis in order to acquire data from the shared memory 11. Accordingly, a processing burden while data is transmitted and received via the shared memory 11 can be reduced. As a result, a data load of the motherboard 10 can be reduced, while the overall performance of the control device 100 can be enhanced.

In addition, the slave device 30 according to the first embodiment includes the diagnosis circuitry 33 that acquires the information regarding the access by monitoring the bus between the CPU 31 and the shared memory 11 (refer to the straight line L with arrows in FIG. 1) and then outputs, to the monitoring circuitry 13, the acquired information regarding the access. As a consequence, the information regarding the access can be acquired with ease only by intercepting the signal output to the bus between the CPU 31 and the shared memory 11 by using the diagnosis circuitry 33. That is, it is not necessary to cause the CPU 31 to carry out processing of outputting, to the monitoring circuitry 13, the information regarding the access, whereby the processing burden of the CPU 31 can be reduced.

Furthermore, the master device 20 according to the first embodiment includes the register 22 that stores the information regarding the access acquired from the monitoring circuitry 13, while the CPU 21 of the master device 20 is configured to access the shared memory 11 on the basis of the register 22. With this, the information regarding the access to the shared memory 11 made by the CPU 31 of the slave device 30 can be acquired with ease only by monitoring the register 22. As a consequence, the shared memory 11 can be efficiently accessed.

### Second Embodiment

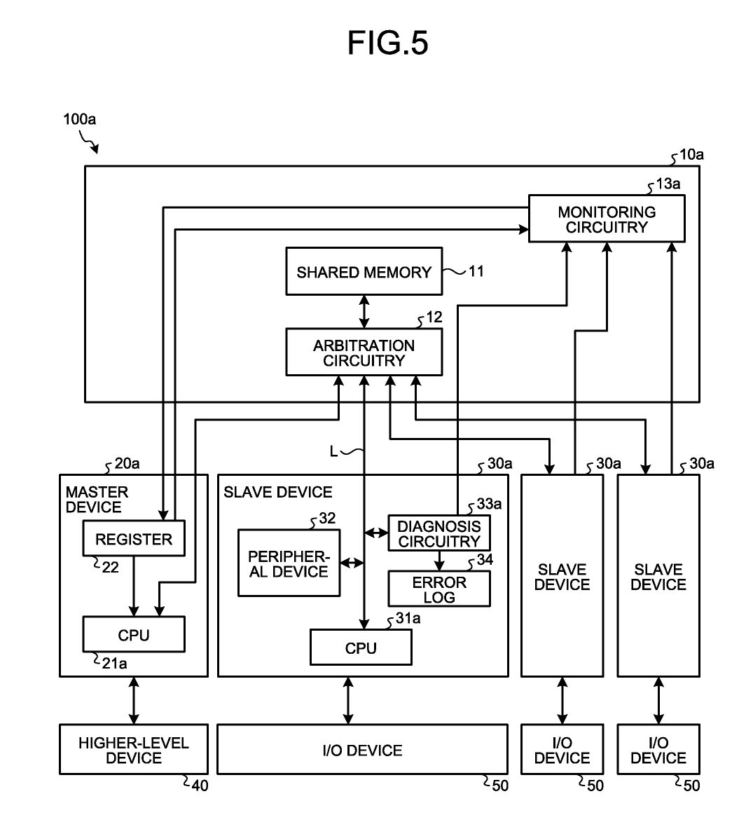

Next, a configuration of a control device 100a according to a second embodiment will be described with reference to FIG. 5. Note that the same reference numerals will be assigned to constituent members similar to those in the first embodiment and the description thereof will be omitted.

As illustrated in FIG. 5, the control device 100a according to the second embodiment includes, as in the control device 100 according to the first embodiment, a motherboard 10a, a master device 20a, and a plurality of slave devices 30a. The master device 20a serves as one example of “first device”, whereas the slave device 30a serves as one example of “second device”. Although FIG. 5 has illustrated an example where the three slave devices 30a are provided, as for the number of the slave devices 30a, four or more slave devices 30a or two or less slave devices 30a may be employed.

The motherboard 10a according to the second embodiment includes a shared memory 11, arbitration circuitry 12, and monitoring circuitry 13a. The monitoring circuitry 13a serves as one example of “first circuitry”. Meanwhile, the master device 20a according to the second embodiment includes a CPU 21a and a register 22. The CPU 21a serves as one example of “first controller”. In addition, the slave device 30a according to the second embodiment includes a CPU 31a, a peripheral device 32, and diagnosis circuitry 33a. The CPU 31a serves as one example of “second controller”, while the diagnosis circuitry 33a serves as one example of “second circuitry”.

Here, the diagnosis circuitry 33a according to the second embodiment is configured to acquire information regarding an error that can occur in the CPU 31a by monitoring a bus between the CPU 31a and the shared memory 11 (refer to a straight line L with arrows in FIG. 5).

For example, in a case where the CPU 31a is set so as to perform an action of repeatedly carrying out a plurality of tasks A, B, C, and D in this order, the diagnosis circuitry 33a is configured to determine whether the CPU 31a is performing an action deviating from the aforementioned setting by intercepting an output signal from the CPU 31a via the aforementioned bus (refer to the straight line L with arrows in FIG. 5). Additionally, the diagnosis circuitry 33a is configured to record, when the CPU 31a is determined to be performing an action deviating from the aforementioned setting, namely, when a certain error is judged to have occurred in the CPU 31a, details of this error as an error log 34 and at the same time, output information regarding this error to the monitoring circuitry 13a of the motherboard 10a.

The monitoring circuitry 13a according to the second embodiment is configured to output, when acquiring the aforementioned information regarding the error from the slave device 30a, the acquired information regarding the error to the master device 20a. More specifically, the monitoring circuitry 13a is configured to write, to the register 22 of the master device 20a, information that can locate which slave device 30a includes the CPU 31a in which the error has occurred when acquiring the aforementioned information regarding the error from the slave device 30a.

The CPU 21a according to the second embodiment is configured to carry out exceptional processing on the basis of the register 22. More specifically, the register 22 is configured to output the interrupt signal to the CPU 21a when the information as mentioned above is written thereto by the diagnosis circuitry 33a. Additionally, the CPU 21a is configured to temporarily stop processing currently being carried out and then carry out the exceptional processing when the interrupt signal is input from the register 22. Processing to initialize the slave device 30a including the CPU 31a in which the error has occurred and processing to separate the slave device 30a including the CPU 31a in which the error has occurred from a system are considered examples of the exceptional processing.

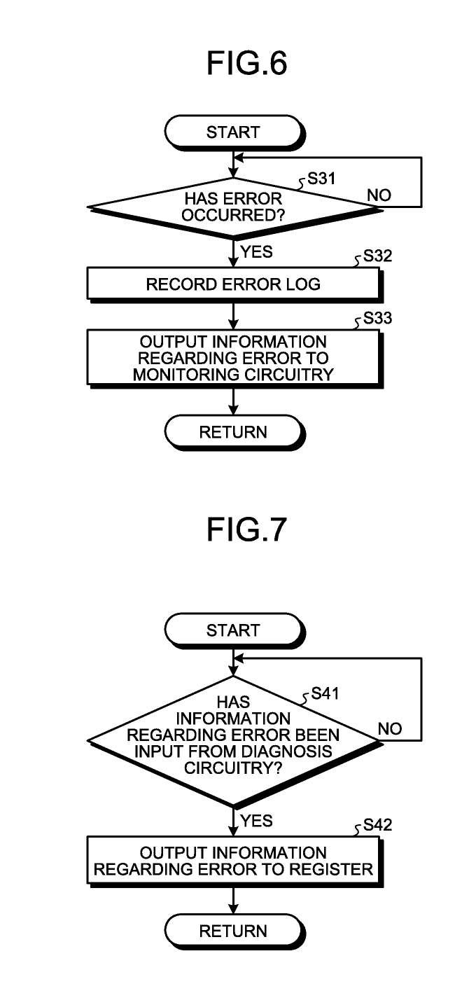

Next, a processing flow carried out by the diagnosis circuitry 33a of the slave device 30a in the control device 100a according to the second embodiment will be described with reference to FIG. 6.

In this processing flow, as illustrated in FIG. 6, the diagnosis circuitry 33a first judges, at step S31, whether an error has occurred in the CPU 31a of the slave device 30a. More specifically, the diagnosis circuitry 33a determines whether the CPU 31a is performing an action deviating from the setting by monitoring the bus between the CPU 31a and the shared memory 11 (refer to the straight line L with arrows in FIG. 5) to intercept, from the bus, the output signal from the CPU 31a. This processing at step S31 is repeated until an error is judged to have occurred in the CPU 31a. When an error is judged at step S31 to have occurred in the CPU 31a, the processing proceeds to step S32.

At step S32, the diagnosis circuitry 33a records the error log 34 indicating details of the error that has occurred in the CPU 31a. Then, the processing proceeds to step S33.

At step S33, the diagnosis circuitry 33a outputs, to the monitoring circuitry 13a of the motherboard 10a, the information regarding the error that has occurred in the CPU 31a. The information regarding the error is generated on the basis of the signal intercepted from the bus between the CPU 31a and the shared memory 11 (refer to the straight line L with arrows in FIG. 5). Then, the processing returns to the beginning.

Next, a processing flow carried out by the monitoring circuitry 13a of the motherboard 10a in the control device 100a according to the second embodiment will be described with reference to FIG. 7.

In this processing flow, as illustrated in FIG. 7, the monitoring circuitry 13a first judges, at step S41, whether the information regarding the error that has occurred in the CPU 31a of the slave device 30a has been input from the diagnosis circuitry 33a. This processing at step S41 is repeated until the information regarding the error is judged to have been input from the diagnosis circuitry 33a. When the information regarding the error is judged at step S41 to have been input from the diagnosis circuitry 33a, the processing proceeds to step S42.

At step S42, the monitoring circuitry 13a outputs, to the register 22 of the master device 20a, the information regarding the error input from the diagnosis circuitry 33a. More specifically, the monitoring circuitry 13a writes, to the register 22, the information that can locate which slave device 30a includes the CPU 31a in which the error has occurred. Then, the processing returns to the beginning.

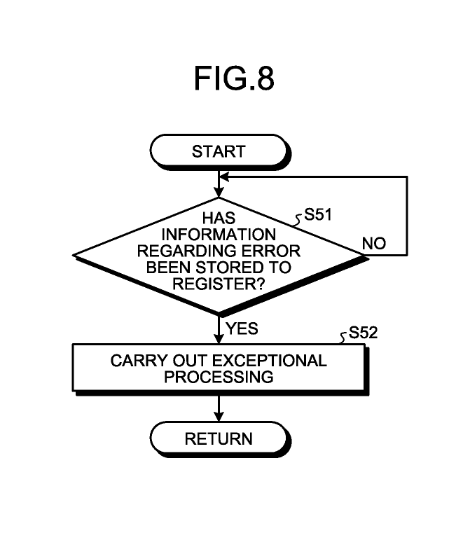

Next, a processing flow carried out by the CPU 21a of the master device 20a in the control device 100a according to the second embodiment will be described with reference to FIG. 8.

In this processing flow, as illustrated in FIG. 8, the CPU 21a first judges, at step S51, whether the information regarding the error that has occurred in the CPU 31a has been stored to the register 22. For example, in a case where the register 22 is configured so as to output the interrupt signal to the CPU 21a when the information regarding the error is stored thereto, the CPU 21a judges, at step S51, whether the interrupt signal from the register 22 has been input to the CPU 21a itself. This processing at step S51 is repeated until the information regarding the error is judged to have been stored to the register 22. When the information regarding the error is judged at step S51 to have been stored to the register 22, the processing proceeds to step S52.

At step S52, the CPU 21a carries out the exceptional processing on the basis of the information regarding the error stored to the register 22. In other words, when an error has occurred in the CPU 31a, the monitoring circuitry 13a writes, to the register 22, the information that can locate which slave device 30a includes the CPU 31a in which the error has occurred. Consequently, at step S52, the CPU 21a reads, from the register 22, the information written to the register 22 by the monitoring circuitry 13a and then, on the basis of the read information, carries out the exceptional processing on the slave device 30a including the CPU 31a that has been located. As described earlier, processing to initialize the slave device 30a including the CPU 31a in which the error has occurred and processing to separate the slave device 30a including the CPU 31a in which the error has occurred from a system are considered examples of the exceptional processing. Then, the processing returns to the beginning.

As described thus far, the control device 100a according to the second embodiment includes the monitoring circuitry 13a that acquires, when an error has occurred in the CPU 31a of the slave device 30a, the information regarding this error from the slave device 30a and then outputs, to the master device 20a, the acquired information regarding the error. With this, processing burdens during mutual detection of whether an error has occurred can be reduced.

That is, in a conventional control device provided with a plurality of processors, the respective processors have mutually detected whether an error has occurred by using a so-called healthy counter using a certain common storage medium (shared memory). For example, the processors have mutually detected whether an error has occurred in such a manner that each one stores, to the shared memory, data indicating that an error has not occurred in the own processor every time a task set in advance is successfully completed and then the data stored in this manner is mutually monitored. As described above, it has been necessary in the past for the respective processors to also carry out a variety of types of processing other than a task set in advance in order to mutually detect whether an error has occurred and thus, the processing burdens have increased in some cases.

In contrast to this, because the control device 100a according to the second embodiment includes the monitoring circuitry 13a as described above, a fact that an error has occurred in the CPU 31a is notified to the master device 20a by the monitoring circuitry 13a that is hardware independent from the CPU 31a. Consequently, according to the second embodiment, it is no longer necessary to carry out processing of, for example, repeatedly accessing the shared memory 11 on a regular basis in order to mutually detect whether an error has occurred and thus, the processing burdens can be reduced.

In addition, the slave device 30a according to the second embodiment includes the diagnosis circuitry 33a that acquires the information regarding the error by monitoring the bus between the CPU 31a and the shared memory 11 (refer to the straight line L with arrows in FIG. 5) and then outputs, to the monitoring circuitry 13a, the acquired information regarding the error. As a consequence, the information regarding the error can be acquired with ease only by intercepting the signal output to the bus between the CPU 31a and the shared memory 11 by using the diagnosis circuitry 33a. That is, it is not necessary to cause the CPU 31a to carry out processing of outputting, to the monitoring circuitry 13a, the information regarding the error and thus, the processing burden of the CPU 31a can be reduced. Meanwhile, because the signal output to the bus between the CPU 31a and the shared memory 11 is intercepted by the diagnosis circuitry 33a, a type of an action performed by the CPU 31a at a time point when an error has occurred can be recorded in detail as the error log 34.

Furthermore, the master device 20a according to the second embodiment includes the register 22 that stores the information regarding the error acquired from the monitoring circuitry 13a, while the CPU 21a is configured to carry out the exceptional processing on the basis of the register 22. As a consequence, the information regarding the error can be acquired with ease only by monitoring the register 22.

Some embodiments according to the present invention have been described thus far. The above-described embodiments merely serve as examples and are not intended to limit the scope of the invention. The above-described embodiments can be carried out in various modes and can be variously omitted, replaced, and modified without departing from the spirit of the invention. The above-described embodiments and the modifications thereof are included in the scope and the spirit of the invention and also included in the scope of the invention disclosed in claims and the equivalents thereof.

1. A control device comprising:
a first device comprising a first controller;
a second device comprising a second controller;
a shared memory configured to be shared by the first device and the second device; and
first circuitry configured: to acquire, when the second controller accesses the shared memory, information regarding the access from the second device; and to output, to the first device, the acquired information regarding the access.

2. The control device according to claim 1, wherein
the second device further comprises second circuitry configured to acquire the information regarding the access by monitoring a bus between the second controller and the shared memory and to output, to the first circuitry, the acquired information regarding the access.

3. The control device according to claim 1, wherein
the first device further comprises a register configured to store therein the information regarding the access acquired from the first circuitry, and
the first controller is configured to access the shared memory based on the information regarding the access stored in the register.

4. A control device comprising:
a first device comprising a first controller;
a second device comprising a second controller;
a shared memory configured to be shared by the first controller and the second controller; and
first circuitry configured: to acquire, when an error has occurred in the second controller, information regarding the error from the second device; and to output, to the first device, the acquired information regarding the error.

5. The control device according to claim 4, wherein
the second device further comprises second circuitry configured to acquire the information regarding the error by monitoring a bus between the second controller and the shared memory and to output, to the first circuitry, the acquired information regarding the error.

6. The control device according to claim 4, wherein
the first device further comprises a register configured to store therein the information regarding the error acquired from the first circuitry, and
the first controller is configured to carry out exceptional processing based on the information regarding the error stored in the register.
